(19) United States
(12) Patent Application Publication
(10) Pub. No.: US 2026/0153729 A1
(43) Pub. Date: Jun. 4, 2026

(54) ULTRA-COMPACT SILICON PHOTONIC SPATIAL SWITCH

(71) Applicants: National Research Council of Canada, Ottawa (CA); The Royal Institute for Advancement of Learning / McGill University, Montreal (CA)

(72) Inventors: Yuri Grinberg, Orleans (CA); Dan-Xia Xu, Gloucester (CA); Rebecca Rogers, Montreal (CA); Odile Liboiron-Ladouceur, Montréal-Ouest (CA)

(73) Assignee: NATIONAL RESEARCH COUNCIL OF CANADA, Ottawa (CA)

(21) Appl. No.: 18/965,018

(22) Filed: Dec. 2, 2024

(51) Int. Cl. G02B 27/00; G02F 1/31

(52) U.S. Cl. CPC G02B 27/0012; G02F 1/31

(57) ABSTRACT

An topologically optimization based design methodology (also known as inverse design) for the ultra-compact design of silicon photonic spatial switches.

### FIELD OF THE INVENTION

This invention relates silicon photonic Spatial switches and more specifically to the ultra-compact design of said switches.

### BACKGROUND

As global data consumption increases, designing interconnects for modern computing platforms to support larger throughput with low latency has become deterministic in meeting the insatiable demand for data processing. As electronics reach a bottleneck in performance at higher data rates, silicon-on-insulator (SOI), with its large refractive index contrast, offers denser off-chip interface interconnect capacity and is compatible with well-established complementary metal-oxide semiconductor (CMOS) fabrication processes. Key devices such as optical switches and splitters are integral in the development of optical interconnects as well as next generation photonic circuits. Despite high modal confinement, however, conventionally designed SOI-based devices have relatively large circuit footprint areas as light diffraction inherently limits the miniaturization that benefits transistors preventing further scaling required for bandwidth density.

Photonic switching and routing in silicon-based integrated circuits is often dependent on MZI (Mach-Zehnder interferometer) structures that are large in footprint. Switches based on Microring resonator (MRR) suffer from high sensitivity to temperature and fabrication process variations forcing strong electronic controls leading to energy-efficiency degradation. As there is an increase of data usage, photonic circuits for interconnects reduced in size that are more stable are needed in order to incorporate more components onto a singular chip.

Such a reduced footprint allows for a higher device density on chip. Currently switching capabilities are realized through structures such as MZI based on thermal effect or on plasma dispersion, or require phase change materials (PCM). Switches based on MZI take up a significant space on the layout. PCM based switches are not as well established in fabrication and often require high switching voltage.

### SUMMARY

The thermal optical inverse designed switch disclosed herein drastically reduces the size requirements for switching on integrated circuits from hundreds of microns down to 10 microns in length.

As per disclosed in greater detail below, according to one aspect of the invention, there is a method of designing a silicon photonic thermal switch having at least one input port, at least one output port, where a signal on said input port is asserted on said output port conditionally in response to the operating temperature, said method comprising establishing switch parameters, establishing a candidate design by layout optimization, evaluating said candidate design according to said switch parameters and in the case of said candidate design not providing the switch parameter set, iterating the method.

Some variants of this aspect also described include (a) in iterating, adjustment of new said switch parameters incorporate inputs relating to temperature response of at least one of the optical core (silicon) and the cladding (silicon dioxide); (b) in the case of said candidate design providing the switch parameter set, accepting the candidate design; (c) the switch parameters comprise at least one of physical space of the switch, at least one switching temperature for which the switch is expected to assert, or not, a photonic signal on a port, conditional on the actual temperature of the switch relative to the switching temperature, switch polarity, wavelength of optical input, the position of any said port, optical loss tolerance on any said output port, responsiveness of the operating temperature to assertion relationship on any output port, sensitivity to fabrication characteristics, temporal response time to operating temperature change.

### BRIEF DESCRIPTION OF THE DRAWINGS

The drawings have not necessarily been drawn to scale. Similarly, some components and/or operations can be separated into different blocks or combined into a single block for the purposes of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

FIG. 1 shows a switch according to the present invention

FIG. 2 shows a method of design of a switch according to the present invention.

### DETAILED DESCRIPTION

In the following description, for the purposes of explanation, numerous specific details are set forth in order to provide a thorough understanding of implementations of the present technology. It will be apparent, however, to one skilled in the art that implementations of the present technology can be practiced without some of these specific details.

The design techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some implementations,” “according to some implementations,” “in the implementations shown,” “in other implementations,” and the like generally mean the particular feature, structure, or characteristic following the phrase is included in at least one implementation of the present technology, and can be included in more than one implementation. In addition, such phrases do not necessarily refer to the same implementations or different implementations.

A silicon photonic thermal switch and method for designing said is described herein.

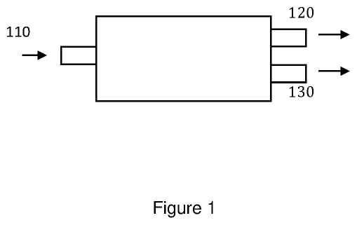

According to FIG. 1 there is a silicon photonic thermal switch. In this switch, a photonic or optical signal is applied to port 110, and based on the temperature of the switch, the photonic signal is asserted to port 120 or port 130. The switch may be formed on a photonic integrated circuit base having both an optical core (silicon) and cladding (silicon dioxide).

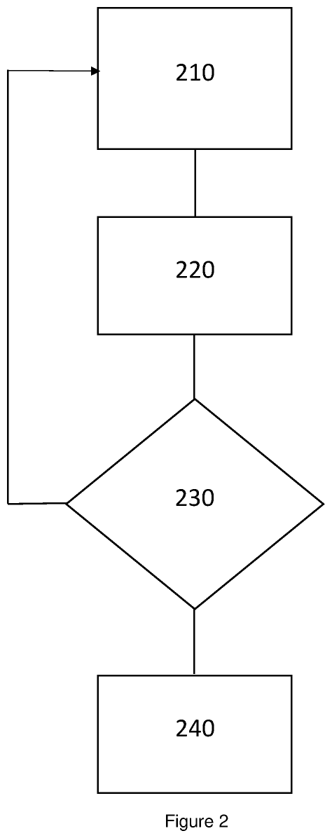

According to FIG. 2 there is a method of designing silicon photonic thermal switches. In step 210, switch parameters are established. Switch parameters are, for example, the physical space of the switch and at least one switching temperature for which the switch is expected to assert, or not, a photonic signal on a port, conditional on the actual temperature of the switch relative to the switching temperature. Switch polarity may also be a parameter, in the sense that an output port may be asserted in either the lower or higher real temperature case. In the case of a 1 (in) to 2 (out) port switch, for example, the person skilled in the art will understand that this can be implemented with 2 ports having the same switching temperature, and opposite switch polarity. Furthermore, it will be understood that the parameters listed above need not be exhaustive. Examples are not limited to the wavelength of optical input, the position of any or all ports, optical loss tolerance on any or all ports, the sensitivity of slope i.e. responsiveness of the temperature to assertion relationship on any individual port, sensitivity to fabrication parameters, and temporal response time to a change in temperature.

The physical space parameter may take the form of, for examples, an area, a length width pair, a radius of a circle, or more sophisticated area such as a defined map of the perimeter. That is to say, it is possible to envision known mathematically defined shapes with the requisite parameters as well as irregularly designed shapes defined in detail.

In step 220, layout optimization, a temperature dependent switch candidate is generated according to the physical space parameter. According to one implementation an inverse-design package such as ANSYS/Lumerical LumOpt may provide this candidate, which is one possible implementation of a density based topology inverse design as taught in “Inverse design in photonics by topology optimization: tutorial” (Journal of the Optical Society of America B Vol. 38, Issue 2, pp. 496-509 (2021)).

According to a 2nd implementation a direct binary search algorithm may be used according to “Inverse design of a nano-photonic wavelength demultiplexer with a deep neural network approach” (Optics Express Vol. 30, Issue 15, pp. 26201-26211 (2022)). According to a 3rd implementation a level set method may be used according to “Robust shape and topology optimization of nanophotonic devices using the level set method” (Journal of Computational Physics 395 (2019): 710-746.).

Still another example of step 220 is disclosed in the inventors upcoming paper Thermal Topological Design for a Compact Silicon Photonic Switch and Tunable Splitter.

According to that embodiment, the objective function of the density topological optimization and initial conditions may be determined to drive the optimizer to a device solution. The design may have one silicon rectangular waveguide with a 550 nm width for the input with the fundamental transverse electric mode (TEO) defined as the light source and two 550 nm wide silicon rectangular waveguides as the output. This design space has a footprint of 10×6 μm2 and is comprised of silicon and silica medium.

During the optimization steps, the gradient function may converge to a local minimum by varying the permittivity of the design region to achieve the desired transmission. A goal of the optimizer in thermal-based topological optimization is to converge to a permittivity distribution that provides the desired optical response to a defined change in temperature. In this example, the optical signal for the proposed thermal switch may propagate with maximum transmission at output 1 at 450 K (T2) and output 2 at 300 K (T1) for a spatial optical switch operation. Hence, a figure of merit may includes an additional term to reflect the change in propagation with permittivity changes due to temperature.

To incorporate the thermo-optic effect into topological optimization design methodologies, the SPINS optimizer developed by Stanford Nanoscale and Quantum Photonics Lab may be employed to perform three dimensional (3-D) Finite Difference Frequency Domain (FDFD) based optimizations. The optimization may be conducted with a 1550 nm wavelength TEO source followed by the wavelength-transmission spectral performance evaluated using a 3-D Finite Difference Time Domain (FDTD) method. The thermo-optic effect is incorporated within the SPINS code at the chosen operating temperatures, T1=300 K (room temperature) and T2=450 K, by ensuring that intermediate permittivity values are evaluated at these temperatures during the optimization steps. To do so, the permittivity values are multiplied by a linear interpolation of the temperature coefficients.

In topological optimization, the initial design space may be comprised of an array of randomized intermediate permittivity values with each component, or pixel, of the array having a 40 nm grid resolution. A normalized permittivity value ρ bounded to [0,1] may be introduced as the optimization parameter. This two-integer boundary is mapped onto the corresponding temperature-dependent permittivity range [ε_{SiO2}, ε_{Si}] where ρ equaling zero and one corresponds to ε_{SiO2} and ε_{Si}, respectively. To incorporate thermal dependency into the optimization, the design space may be optimized using the two permittivity distributions reflecting the two operating temperatures of operation. For optical materials, the temperature dependence of permittivity can be defined as ε=ε0+τΔT where ε is the adjusted permittivity from a temperature change ΔT, ε0 is the reference permittivity at room temperature (300 K), and τ is the temperature coefficient of the material. The permittivity can further be expressed in terms of ρ and T as: ε(ρ, T) =ε_{SiO2}(T)+ρ·(εSi(T)−ε_{SiO2}(T)).

At a constant temperature, the above equation may establish the characteristic linear relationship between the values of ρ and the permittivity values of silicon and silica, as utilized in topology optimization. An adjustment may enable a thermal dependent design space. As such, the temperature coefficient T may be artificially interpolated between silicon and silica through ρ, adding temperature in the iterative optimization as τ(ρ)=ρ·(T_{Si}−T_{SiO2}) where the temperature coefficients of silicon (τSi) and silica (τSiO2) at 1.55 μm, are 1.86×10⁻⁴ K⁻¹ and 1.50×10⁻⁵ K¹, respectively. As the optimization leverages non-physical intermediate values of the temperature coefficients leading to temperature changes in non-physical materials, the binarization process may result in manufacturable materials.

This results in a change in the silicon relative permittivity values between the two temperatures. Silica has a much smaller change in permittivity.

To enhance the thermo-optic effect in small footprints, silicon content may be varied, since temperature coefficient is approximately ten times greater for silicon. The initialization step defining the starting permittivity values at each pixel may include a bias towards silicon for greater effective index changes. The half-way intermediate permittivity value typically used at initialization of the permittivity matrix may be set to 80% of silicon. This bias leads the optimizer to generate a device with a larger amount of silicon features. The convergence pushes the optimization process to generate a device with a greater phase change to enhance the change in the propagation direction of the optical signal at higher temperatures. Indeed, bulk silicon achieves up to a spectral shift of 80 pm/K. In topologically optimized designs, the phase changes are effectively lowered by the presence of silica features. By decreasing the size and amount of these silica features, the phase change of the device is increased leading to more efficient switching capacity.

A byproduct of this design may be beam splitter functionality, which occurs at the halfway point of the temperature range. A skilled person will understand that this embodiment, by proper selection of the temperature and sensitivity parameters discussed above, results in such an effective beam splitter.

A person skilled in the art will understand that there are several presently available alternatives to this step and that the above examples are non-exhaustive.

In step 230, the candidate of step 220 is evaluated regarding satisfaction of the parameters provided in step 210. Based on a positive evaluation, in step 240, the candidate is accepted. On the other hand, based on a negative evaluation, we may return to step 210. According to various embodiments, on such a return to step 210, the parameters may be iterated in order to arrive at a design that does achieve a positive evaluation.

In another alternative embodiment, at step 240, a positive design may also be iterated, but in this case, parameters may be more stringent rather than relaxed. Of course, according to this method embodiment, failure will eventually be achieved, and the penultimate parameters may then be relaxed. The relaxation may be to a previous positive, or, in another example, the step size of iteration may be reduced for further testing.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order, and some processes or blocks may be deleted, moved, added, subdivided, combined, and/or modified to provide alternative or sub-combinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements, blocks and acts of the various implementations described above can be combined to provide further implementations.

Any patents and applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects may likewise be implemented in a computer-readable medium. Accordingly, the inventors reserve the right to add additional claims after filing the application to pursue such additional claim forms for other aspects of the technology.

1. A method of designing a silicon photonic thermal switch having at least one input port, at least one output port, where a signal on said input port is asserted on said output port conditionally in response to the operating temperature, said method comprising:
(i) establishing switch parameters
(ii) establishing a candidate design by layout optimization
(iii) evaluating said candidate design according to said spatial switch parameters
(iv) in the case of said candidate design not providing the switch parameter set, iterating the method from step (i).

2. The method of claim 1 wherein, in the iterating in step (iv), adjustment of new said switch parameters for repeating said step (i), said new switch parameters incorporate inputs relating to temperature response of at least one of the optical core (silicon) and the cladding (silicon dioxide).

3. The method of claim 1 wherein, in the case of said candidate design providing the switch parameter set, accepting the candidate design.

4. The method of claim 1 wherein the switch has 2 output ports.

5. The method of claim 1 wherein the switch parameters comprise at least one of physical space of the switch, at least one switching temperature for which the switch is expected to assert, or not, a photonic signal on a port, conditional on the actual temperature of the switch relative to the switching temperature, switch polarity, wavelength of optical input, the position of any said port, optical loss tolerance on any said output port, responsiveness of the operating temperature to assertion relationship on any output port, sensitivity to fabrication characteristics, temporal response time to operating temperature change.

6. A silicon photonic thermal switch designed according to the method of claim 1.

7. A method of designing a silicon photonic switch having at least one input port, at least one output port, where a signal on said input port is asserted on said output port conditionally in response to change of the refractive index, said method comprising:
(i) establishing switch parameters
(ii) establishing a candidate design by layout optimization
(iii) evaluating said candidate design according to said spatial switch parameters
(iv) in the case of said candidate design not providing the switch parameter set, iterating the method from step (i).

8. The method of claim 7 wherein, in the iterating in step (iv), adjustment of new said switch parameters for repeating said step (i), said new spatial switch parameters incorporate inputs relating to one of refractive index changes and voltage/current response of at least one of the optical core (silicon) and the cladding (silicon dioxide).

9. The method of claim 7 wherein, in the case of said candidate design providing the spatial switch parameter set, accepting the candidate design.

10. The method of claim 7 wherein the switch has 2 output ports.

11. The method of claim 7 wherein the switch parameters comprise at least one of physical space of the switch, at least one switching temperature or voltage/current for which the switch is expected to assert, or not, an optical signal on a port, conditional on the actual refractive index change of the switch relative to switch voltage, switch current, switch polarity, wavelength of optical input, the position of any said port, optical loss on any said output port, responsiveness of the operating temperature or voltage/current to assertion relationship on any output port, sensitivity to fabrication characteristics, temporal response time to operating temperature or voltage/current change.

12. A silicon photonic spatial switch designed according to the method of claim 7.

13. The method of claim 7 wherein said change of the refractive index correlates to plasma dispersion.
